(19) United States
(12) Patent Application Publication
(10) Pub. No.: US 2006/0016344 A1
(43) Pub. Date: Jan. 26, 2006

(54) Coffee vending machine using coffee concentrate

(75) Inventors: Myoung-Gu Kim, Inchon-si (KR); Chong-Du Cho, Seoul (KR); Jung-Yeob Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Inha-Industry Partnership Institute

(21) Appl. No.: 11/049,664

(22) Filed: Feb. 4, 2005

(30) Foreign Application Priority Data
Jul. 22, 2004 (KR) 10-2004-0057373

(51) Int. Cl. A23L 1/00

(52) U.S. Cl. 99/275

(57) ABSTRACT

Disclosed herein is a coffee vending machine, in which a concentrate of coffee, cream, sugar, or the like is supplied to an agitator by using a screw-pump, and the supplied concentrate is mixed with hot water from a hot water supply to thereby automatically produce a coffee drink. The coffee vending machine includes a raw material container for containing a concentrate of coffee, cream, and sugar, a screw-pump disposed below the raw material container and for transferring the concentrate supplied from the raw material container into the lower portion thereof by means of a screw, an opening and closing means disposed below the screw-pump and for opening and closing a concentrate discharge-duct, an agitator disposed below the valve and for dissolving the concentrate into water, and a hot water supply for supplying hot water into the agitator.

### BACKGROUND OF THE INVENTION

1. Field of the Invention

The present invention relates to a coffee vending machine. More specifically, the invention relates to a coffee vending machine, in which in which a concentrate of coffee, cream, sugar, or the like is supplied to an agitator by using a screw-pump, and the supplied concentrate is mixed with hot water from a hot water supply to thereby automatically produce a coffee drink.

2. Description of the Prior Art

In general, an automatic vending machine is an unattended device for selling various commodities, including a cupped drink, a canned drink, a disposable product, or the like.

Among them, a coffee vending machine is an apparatus for selling a cupped drink.

A conventional coffee vending machine is provided with a raw material container for storing a raw material powder and a hot water supply for supplying a hot water. An agitator is disposed below the raw material container and mixes the supplied raw material and the hot water to make a drink.

The conventional automatic vending machine having the above-described construction produces a drink such as a coffee by mixing the raw material from the raw material container and the water from the hot water supply in the agitator.

The above produced drink is discharged via a discharge duct into a cup resting on a cup withdrawer, from which a user withdraws the drink.

The above-described conventional automatic vending machine embraces the following problems.

First, a sludge of undissolved raw material powder remains in the agitator, in which the raw materials are mixed, thereby leading to a sanitary problem.

In order to solve this problem, extra water may be supplied to the agitator to wash the mixer, but it does not provide a complete solution.

The remaining sludge is fixed and hardened to the agitator, then changes in quality, and is released with the next mixed drink, thereby resulting in degraded taste and being unsanitary.

Second, the raw material powder inside the automatic vending machine often is hardened due to a steam introduced into the agitator and a moisture in the air, in particular in summer time.

Therefore, the rotating torque of a screw for supplying the raw material into the agitator is overly increased, so that a motor for driving the screw becomes overloaded.

Where this situation continues for some time, the vane of the screw may be broken or the motor fails, so that the automatic vending machine cannot be used, which leads to an inconvenience and an economical loss.

Third, since the raw material is supplied into the agitator in a state of powder, it cannot be easily dissolved in water within a short period of time and may remain at the bottom of the cup in an undissolved state.

Therefore, the user cannot drink the coffee drink right after it is discharged from the machine and must stir it further using a stick or the like or wait for a few minutes.

### SUMMARY OF THE INVENTION

The present invention has been made in order to solve the above problems in the art, and it is the first object of the invention to provide an automatic vending machine, in which a liquid raw material of coffee, cream and sugar can be used, instead of conventional powdered raw materials, so that the liquid raw material can be completely dissolved, to thereby provide sanitary and delicious coffee drink.

The second object of the invention is to provide an automatic vending machine, in which a liquid raw material can be used, instead of conventional powdered material, thereby preventing hardening of the raw material during a long-term storage, and an agitator is shielded from a raw material container by means of a valve, so that unnecessary steam is prevented from seeping into the raw material container.

The third object of the invention is to provide an automatic vending machine, in which a liquid raw material is used to produce a drink mixture, and thus the liquid raw material is completely dissolved rapidly inside the agitator, so that a user can drink the coffee right after it is discharged, and a sludge can be prevented from remaining at the bottom of the cup.

### BRIEF DESCRIPTION OF THE DRAWINGS

Other objects and advantages of the present invention will become apparent from the following description when taken in conjunction with the accompanying drawings, in which:

FIG. 1 shows a construction of a coffee vending machine related to the embodiments of the invention;

FIG. 2 illustrates a cross-section of a screw-pump in a coffee vending machine according to the invention;

FIG. 3a is a vertical cross-section showing an opening and closing means of a coffee vending machine according to the invention; and

FIG. 3b is a vertical cross-section showing an operation of the opening and closing means in a coffee vending machine of the invention.

### DETAILED DESCRIPTION OF THE INVENTION

In order to accomplish the above objects, according to the present invention, there is provided an automatic vending machine, in which water is mixed with a raw material such as coffee, cream, and sugar, to produce a drink. The automatic vending machine comprises: a raw material container for storing a concentrate of coffee, cream, and sugar; a screw-pump disposed below the raw-material container and for conveying the concentrate supplied from the raw material container in a downward direction; an opening and closing means disposed below the screw-pump and for opening and closing a concentrate discharge duct; an agitator disposed below the opening and closing means and for dissolving the concentrate into water; and a hot water supply for supplying hot water into the agitator.

The screw pump 30 includes: a fluid chamber 38 formed at the center of the inside thereof; a housing 31 having a concentrate inlet 32 and a concentrate outlet 33; a first and second screw shaft 34 and 36 mounted inside the fluid chamber 38 and having a driver screw 35 and a follower screw 37 formed thereon, respectively, such a manner as to rotate in opposite directions to each other; a helical gear 40-43 formed at one end of the respective screw shafts 34, 36 and rotating in opposite directions to each other, the tooth of the helical gear being formed twisted at a certain angle; and a drive motor 39 connected to one end of the first screw shaft 34.

The opening and closing means includes: a poppet valve disposed at the intermediate of the concentrate discharge-duct; an adjustment bolt disposed spaced apart from the poppet valve, the head of the adjustment bolt being projected outside; and a spring disposed between the poppet valve and the adjustment bolt, wherein, when above a certain pressure, the poppet valve is pushed back to open the concentrate discharge duct, and when below the certain pressure, the poppet valve is returned to its original position to close the concentrate discharge duct.

The preferred embodiments of the invention of the invention will be described in detail, with reference to the accompanying drawings.

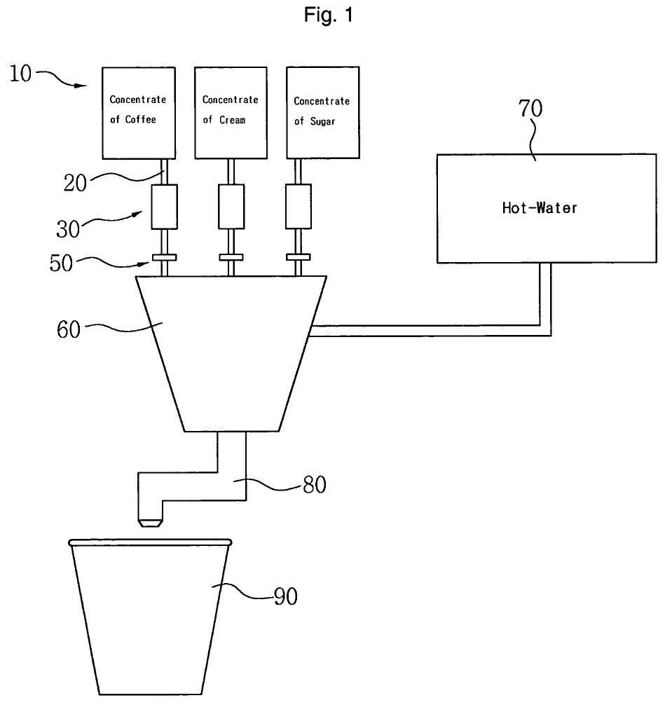

FIG. 1 shows a construction of a coffee vending machine related to the embodiments of the invention. The coffee vending machine according to the invention includes a raw material container 10, a screw-pump disposed below the raw material container 10, an opening and closing means 50 disposed below the screw pump 30, an agitator 60 disposed below the opening and closing means 50, and a hot water supply 70 for supplying hot water into the agitator 60.

In addition, the agitator 60 has a coffee discharge duct 80 and a cup 90 provided at the lower portion thereof, which is used in a conventional automatic vending machine.

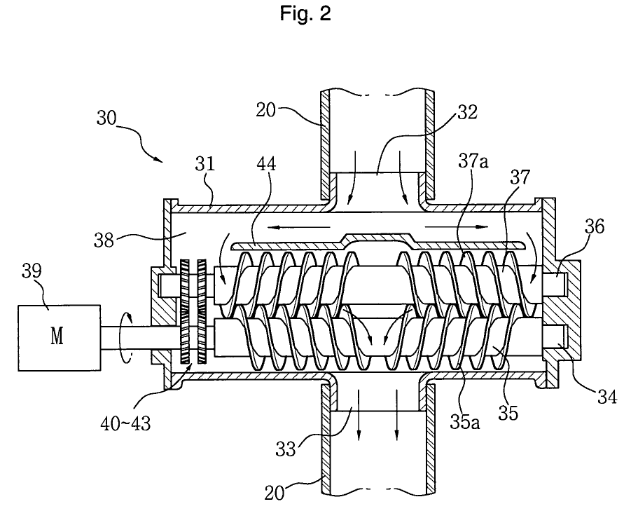

FIG. 2 illustrates a cross-section of a screw-pump in a coffee vending machine according to the invention. The screw pump is disposed between below the raw material container and above the opening and closing means.

The screw-pump 30 comprises a fluid chamber 38 formed at the center of the inside thereof, and a housing 31 disposed below the fluid chamber 38. The housing 31 has a concentrate inlet 32 disposed above the fluid chamber 38 and for introducing a concentrate from the raw material container 10, and a concentrate outlet 33 for discharging the concentrate inside the fluid chamber 38 into the opening and closing means 50.

In addition, the fluid chamber 38 is provided with a first and second screw shafts 34, 36 there inside, which rotate in opposite direction to each other and have respectively a driver screw 35 and a follower screw 37. The first and second screw shafts 34, 36 is provided respectively with a helical gear 40-43 formed at one end thereof, which are rotated in opposite directions to each other and whose gear teeth are twisted at a certain angle.

One end of the first screw shaft 34 is connected to a drive motor 39. The reason why the helical gear is employed for the screw pump, instead of a spur gear, is that a helical gear can rotate smoothly and silently and can transfer a larger torque, as compared with a spur gear.

In addition, the helical gears may be disposed outside the housing 31, dissimilar to that illustrated in the drawings.

The driver screw 35 formed on the first screw shaft 34 is formed of a right-handed screw, and the follower screw 37 of the second screw shaft 36 is formed of a left-handed screw, which is rotated engaged with the driver screw 35. Here, the driver and follower screw 35, 37 is not formed in the central portion of the first and second screw shaft.

In addition, a shielding wall 44 is formed between the second screw shaft 36 and the concentrate inlet 32 in a longitudinal direction by a length, which corresponds to that of the follower screw 37.

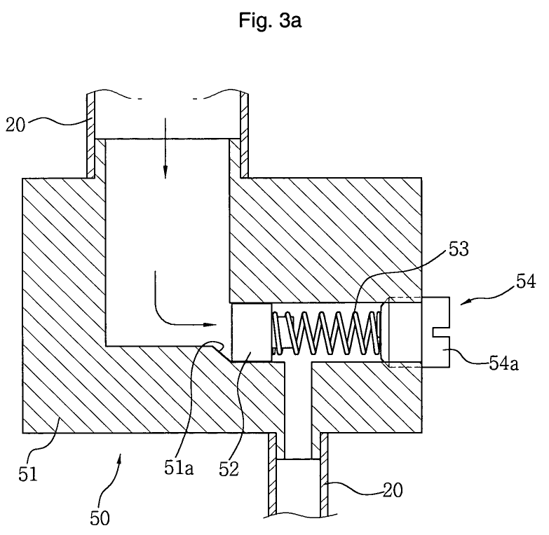

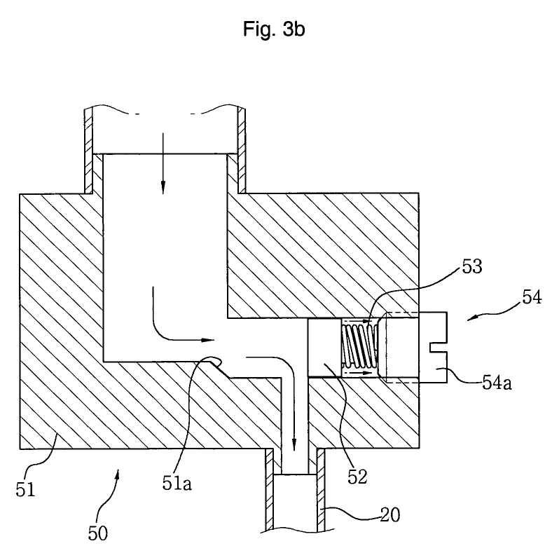

FIG. 3a illustrates the opening and closing means 50 of the coffee vending machine according to the invention, where a poppet valve 52 and an adjustment bolt 54 are positioned at a valve body 51 formed in the center of the concentrate discharge duct 20.

A spring 53 is interposed between the poppet valve 52 and the adjustment bolt 54, so in such a manner that, when above a certain desired pressure, the poppet valve 52 is pushed back to open the concentrate discharge duct 20, and when below the certain desired pressure, the poppet value 52 is returned to its original position to close the concentrate discharge duct 20.

Here, the certain desired pressure may be adjusted by rotating the adjustment bolt 54.

Furthermore, a projection step 51a is formed in the path along which the poppet valve 52 is pushed back. The projection step 51a is formed forwards of the poppet valve 52, and integrally formed with the valve body 51.

When the concentrate does not exert any pressure, the poppet valve 52 is biased forwards by the force of the spring 53 so that it becomes contacted with the projection step 51a.

The operation of the coffee vending machine having the above construction will be explained below.

As described above, the concentrate inside the raw material container 10 is introduced into the screw-pump 30 via the concentrate discharge duct 20.

The concentrate introduced into the screw-pump 30 is transferred to the opening and closing means 50 positioned there below as the screw-pump 30 operates. The concentrate transferred to the opening and closing means 50 flows into the agitator disposed there below while pushing the poppet valve 52.

The above concentrate transferred into the agitator is mixed and diluted with a hot water from the hot water supply 70, and therefore the concentrate and water forms a mixture rapidly. The mixture rapidly produced in the agitator 60 falls into the cup 90 through the discharge duct 80.

The above agitator is a device for mixing coffee and hot water in a conventional coffee vending machine, and the discharge duct for conveying the mixed coffee and the cup for containing the conveyed mixture are identical to those of a conventional device. Therefore, details on these components will not be described here.

FIG. 2 is a cross-section showing the screw-pump 30 in the above coffee vending machine. As the drive motor 39 connected to the first crew shaft is operated, the driver screw 35 is rotated in one direction and the follower screw 37 engaged therewith is rotated in the opposite direction.

Therefore, at this time, the concentrate introduced through the concentrate inlet 32 formed above the housing 31 is separated right and left by hitting the shielding wall 44 formed at the center of the housing. The separated concentrate is introduced into both end portions of the first and second shafts 34, 36.

The introduced concentrate as described above is advanced with filled between the threads 35a, 37a of the driver screw 35 and the follower screw 37 and collected into the central portion of the first and second shafts 34, 35.

The collected concentrate at the center portion is discharged through the concentrate outlet 33 formed below the housing 31 by means of the concentrate, which is continuously flown into from the driver screw 35 and the follower screw 37. The concentrate discharged from the concentrate outlet 33 is transferred into the opening and closing means 50 through the discharge duct 20.

As a device for conveying the concentrate having a high viscosity, a gear pump is often used, together with the above screw-pump. In the present invention, a screw-pump is employed for the following reasons.

First, the gear pump includes two gears having an identical form, which are interlocked with each other to convey the concentrate. It has advantageously a simply and light structure.

In the above-described gear pump, however, the concentrate conveying part is short, as compared with a screw pump, so that a leakage of concentrate may take place and it cannot easily pressurize a fluid of high viscosity. In addition, the fluid of high viscosity cannot flow smoothly, due to its low discharging pressure.

Therefore, in the case of the device of the invention, where the concentrate has a high viscosity and the air-tightness of concentrate is required, the screw pump is suitable rather than a gear pump.

FIGS. 3a and 3b show a vertical cross-section of the poppet valve 52, which is one embodiment of the opening and closing means 50 in the coffee vending machine according to the invention. The poppet valve 52 operates between the projection step 51a formed in the valve body 51 and the adjustment bolt 54.

When the screw-pump 30 is not operated and thus no fluid is introduced, the poppet value 54 remains contacted with the projection step 51a placed at the front side by the resilient force of the spring 53 placed at the rear side, and thus the concentrate discharge duct stays closed.

Afterwards, when the screw-pump 30 is operated to input the concentrate through the concentrate discharge duct 20 and the pressure of the concentrate is above a certain value, the poppet valve 52 supported resiliently by the spring 53 is pushed back toward the adjustment bolt 54.

As described above, when the poppet valve 52 is pushed back to open the concentrate discharge-duct 20, the concentrate flows into the agitator placed at the lower side through the concentrate discharge duct 20.

Upon completion of the discharge of concentrate, the poppet valve 52 is returned to its original position by means of the resilient force of the spring 53 to close the discharge duct 20 as before.

Here, the pressure for pushing the poppet valve 52 is provided by the screw-pump 30. That is, when the screw-pump is operated to push the concentrate, the pressure of the concentrate is exerted on the poppet valve 52. If the operation of the screw-pump 30 is terminated, the pressure of the concentrate is vanished.

In addition, the resilient force of the spring 53 can be carried out by the adjustment bolt 54. The user can turn the projected heat 54a of the adjustment bolt 54 by using a screw driver or the like in order to compress or loose the spring 53, to thereby obtain a desired spring force.

As described above, if the gap between the poppet valve 52 and the adjustment bolt 54 is narrowed, the resiliency of the spring 53 is increased so that the operation of the poppet valve 52 requires a higher pressure of the concentrate than before the adjustment of the adjustment bolt. If the gap between the poppet valve 52 and the adjustment bolt 54 is widened, the resiliency of the spring 53 is decreased so that the poppet valve 52 can be operated at a lower pressure of the concentrate than before the adjustment of the adjustment bolt 54.

Therefore, the user can set up a desired initial state, and then adjust conveniently the resilient force of the spring by returning the adjustment bolt 54 projected outside.

Besides the above-described valve, various other types of valve may be employed, for example, a sensor-controlled device where a valve can be opened and closed in certain time-intervals.

### EFFECTS OF THE INVENTION

The coffee vending machine having the above-described construction has the following effects.

First, the raw material in the form of concentrate is completely dissolved inside the agitator, thereby maintaining the cleanliness of the inside thereof.

Second, as described above, the concentrate does not remain inside the agitator so that its sludge is not mixed with the next drink mixture, thereby maintaining the same flavor of the drink.

Third, a separate shielding means is provided between the raw material and the agitator so that the steam introduced into the agitator does not flow into the concentrate, thereby preventing a change in the quality of concentrate.

Fourth, the liquid raw material is mixed with hot water to produce a drink mixture, and thus the raw material is rapidly dissolved, as compared with a powdered raw material, so that the user can drink the coffee drink right after it is filled in a cup, without the necessity of further stirring with a stick or the like or waiting for a while.

What is claimed is:

1. An automatic vending machine, in which water is mixed with a raw material such as coffee, cream, and sugar, to produce a drink, comprising:
a) a raw material container for storing a concentrate of coffee, cream, and sugar therein;
b) a screw-pump disposed below the raw material container and for conveying the concentrate supplied from the raw material container in a downward direction;
c) an opening and closing means disposed below the screw-pump and for opening and closing a concentrate discharge duct;
d) an agitator disposed below the opening and closing means and for dissolving the concentrate into water; and
e) a hot-water supply for supplying hot water into the agitator.

2. An automatic vending machine according to claim 1, wherein the screw pump includes:
a) a fluid chamber 38 formed at the center of the inside thereof;
b) a housing having a concentrate inlet and a concentrate outlet;
c) a first and second screw shaft mounted inside the fluid chamber and having a driver screw and a follower screw formed thereon, respectively, such a manner as to rotate in opposite directions to each other;
d) a helical gear formed at one end of the respective screw shafts and rotating in opposite directions to each other, the tooth of the helical gear being formed twisted at a certain angle; and
e) a drive motor connected to one end of the first screw shaft.

3. An automatic vending machine according to claim 1, wherein the opening and closing means includes:
a) a poppet valve disposed at the intermediate of the concentrate discharge duct 20;
b) an adjustment bolt disposed spaced apart from the poppet valve, the head of the adjustment bolt being projected outside; and
c) a spring disposed between the poppet valve and the adjustment bolt,
d) wherein, when above a certain pressure, the poppet valve is pushed back to open the concentrate discharge duct, and when below the certain pressure, the poppet valve is returned to its original position to close the concentrate discharge duct.
